(19) United States
(12) Patent Application Publication
(10) Pub. No.: US 2006/0286334 A1
(43) Pub. Date: Dec. 21, 2006

(54) Absorbent non-woven mat having perforations or scoring

(75) Inventor: Gregory Scott Harpole, (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Batam, LLC

(21) Appl. No.: 11/156,017

(22) Filed: Jun. 17, 2005

(51) Int. Cl. G09F 3/00

(52) U.S. Cl. 428/43; 428/138; 428/101

(57) ABSTRACT

An absorbent mat designed to be placed on hospital floors in order to catch and absorb bodily fluids and other liquids. The mat has multiple layers of nonwoven materials laminated to a liquid-impermeable film layer. According to one embodiment, the mat is perforated or scored through at least part of the absorbent portion of the mat and may be easily torn along the perforations or scoring marks so that segments of the mat may be conveniently separated from one another. According to another embodiment, the nonwoven portion of the mat includes an upper hydrophilic spunbond or needle punched layer and lower hydrophilic meltblown layer or, alternatively, an upper hydrophilic spunbond or needle punched layer, intermediate hydrophilic meltblown layer, and lower hydrophobic spunbond layer.

### BACKGROUND OF THE INVENTION

The invention relates to absorbent mats and methods of using absorbent mats to absorb liquids. More particularly, the invention relates to the use of absorbent floor mats to absorb bodily fluids and other liquids produced in a hospital operating room.

Absorbent mats are sometimes placed on the floors of operating rooms during surgeries in order to absorb water, blood, or other bodily fluids that might escape to the floor. During several types of surgeries, large amounts of liquid are produced, much of which escapes to the floor. Absorbent mats are sometimes used under and around the operation to collect and retain those liquids that fall to the floor. The mats control runoff of the liquid and confine it to the operating area. The mats, which may be discarded, treated, or destroyed after the operation, also provide for easy clean up and disposal of biohazardous material.

Currently available absorbent mats are lacking in several aspects. First, most mats are not sufficiently absorbent to absorb large volumes of liquid evolved during surgery. Further, foot traffic tends to wear through the upper surface of the mats and also tends to cause the mats to slip or gather under the hospital staff. Also, the mats tend to be unwieldy and difficult to remove once loaded with liquid.

It is desired to produce an absorbent mat suitable for use in an operating room. The desired mat would be sufficiently absorbent, would be wear resistant, and would provide for convenient removal, even when loaded with liquid. Further, the desired mat would provide sure footing for the hospital staff during use.

### BRIEF SUMMARY OF THE INVENTION

The invention is an absorbent mat designed to be placed on hospital floors in order to catch and absorb bodily fluids and other liquids. The mat has multiple layers that provide toughness and absorbency but that also prevent liquid from leaking through the mat. The mat may be perforated or scored through at least part of the absorbent portion of the mat and may be easily torn along the perforations or scoring marks so that segments of the mat may be conveniently separated from one another.

The mat comprises a laminate of nonwoven layers, with each layer having one or more plies, bonded to a liquid-impermeable polymer film layer. The nonwoven layers of the laminate are advantageously adhered together, such as by an overall thermal bonding process, spot bonding process, needle punching, or other bonding process to form a laminate having an upper and a lower surface. The thin film layer is adhered to the lower surface of the nonwoven laminate. The polymeric film, which is preferably polyolefin, is liquid-impermeable and advantageously exhibits anti-slip characteristics when in contact with a flooring surface.

The nonwoven laminate portion of the mat is comprised of an upper spunbond or needle punched nonwoven layer adjacent to an underlying intermediate meltblown nonwoven layer that is, in turn, adjacent to the film layer. Alternatively, the nonwoven laminate is comprised of an upper spunbond or needle punched nonwoven layer adjacent to an underlying intermediate meltblown nonwoven layer adjacent to an underlying lower spunbond layer that is, in turn, adjacent to the film layer.

According to a first embodiment, the fibers of the upper layer are either produced as hydrophilic fibers or are treated to enhance their hydrophilicity, and the fibers of the lower spunbond layer, if present, are either produced as hydrophobic fibers or are later treated to enhance their hydrophobicity. The fibers of the meltblown layer are advantageously hydrophilic or treated to be hydrophilic. If treated, the fibers are advantageously treated prior to the nonwoven laminate being bonded to the film layer, but may be treated after the film layer is bonded to the laminate.

According to a second embodiment, the nonwoven laminate is perforated or scored through at least a portion of its thickness so that the end user may easily tear the mat into segments. To make the perforations or score marks, the non-woven layers are assembled to form the laminate and then perforated or scored, typically in the machine-direction, cross-direction, or both. The polymeric film layer is then applied to and adheres to the lower surface of the nonwoven laminate. The resulting non-perforated film layer is sufficiently thin and made of a material that does not interfere with the tearing of the mat along the perforations/scoring and thus the liquid impermeable mat may be easily separated into segments for disposal.

According to a third main embodiment, the attributes of the first and second main embodiments are combined. Namely, the mat of the third embodiment comprises a scored or perforated nonwoven laminate having an upper hydrophilic spunbond or needle punched nonwoven layer and an intermediate hydrophilic meltblown layer or, alternatively, an intermediate hydrophilic meltblown layer and a lower hydrophobic spunbond layer, with a liquid-impermeable film layer adhered to the lower surface of the laminate.

The lower hydrophobic spunbond layer, if used, provides various advantages to the mat. First, the lower hydrophobic spunbond layer provides an extra moisture barrier in addition to the film layer, which reduces the chance of liquid leakage due to any imperfections or penetrations of the film layer. Also, the lower spunbond material tends to bond favorably to the film layer thereby providing added cohesiveness to the mat and preventing separation of the film layer during use or during tearing of the film layer after use.

The upper layer of the laminate may be a spunbond layer, a needle punched layer of any type of nonwoven fibers, or a layer that is both needle punched and spunbond. Further, the layers of the nonwoven laminate may be collectively needle punched to bond the layers of the laminate by mechanical entanglement of the fibers.

The invented mat provides several advantages over previous absorbent mats. The upper spunbound or needle punched layer provides a durable upper surface that can withstand repeated wear and tear, such as being walked upon or rolled over by a castered chair. The meltblown layer provides favorable liquid absorbance and retention characteristics. Also, the hydrophilic upper layers of the mat improve performance of the mat by collecting and maintaining the liquid load within the hydrophilic layers

The lower spunbond layer, if used, provides favorable liquid barrier characteristics when used as the bottom layer of the laminate in contact with the thin film and keeps liquid from passing through the mat during use, even if the liquid-impermeable film layer is breached. The polymer film layer provides a liquid-impermeable barrier and also advantageously provides the mat with a non-slip surface to provide sure footing for those using the mat.

The perforations or scoring within the nonwoven material provide the ability to easily tear the mat into segments after use. Each segment of the mat may be separated and disposed of without the need to handle a large unitary mat loaded with liquid. By perforating or scoring the nonwoven material but not the film layer, the mat remains impermeable to liquid during use.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a cutaway perspective view of the absorbent mat according to one embodiment of the invention;

FIG. 2 is a cutaway perspective view of the absorbent mat according to another embodiment of the invention; and

FIG. 3 is a perspective view of the absorbent mat showing the scoring or perforations according to an embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used herein, terms such as “upper”, “intermediate”, and “lower” are used as positional terms to identify the orientation of the various layers of the mat with respect to one another and are not otherwise limiting to the description or use of the mat. As used herein, the term “laminate” is used to describe a nonwoven structure having multiple layers where each layer is contacted in a face-to-face relationship with its adjacent layer or layers.

As used herein, the term “nonwoven” refers to a fabric that has a structure of individual fibers or filaments which are randomly and/or unidirectionally interlaid in a mat-like fashion. Nonwoven fabrics can be made from a variety of processes including, but not limited to, air-laid processes, wet-laid processes, hydroentangling processes, staple fiber carding and bonding, and solution spinning. Suitable nonwoven fabrics include, but are not limited to, spunbonded fabrics, meltblown fabrics, wet-laid fabrics, hydroentangled fabrics, spunlaced fabrics and combinations thereof.

As used herein, the term “spunbond layer” refers to a nonwoven fabric web of small diameter continuous filaments which are formed by extruding a molten thermoplastic material, or coextruding more than one molten thermoplastic material, as filaments from a plurality of fine, usually circular, capillaries in a spinnerette with the diameter of the extruded filaments then being rapidly reduced, for example, by non-eductive or eductive fluid-drawing or other well known spunbonding mechanisms. These small diameter filaments are substantially uniform with respect to each other. The diameters that characterize these filaments range from about 7 to 45 microns, preferably from about 12 to 25 microns. The production of spunbonded nonwoven webs is illustrated in patents such as Appel et al., U.S. Pat. No. 4,340,563; Dorschner et al., U.S. Pat. No. 3,692,618; Kinney, U.S. Pat. Nos. 3,338,992 and 3,341,394; Levy, U.S. Pat. No. 3,276,944; Peterson, U.S. Pat. No. 3,502,538; Hartman, U.S. Pat. No. 3,502,763; Dobo et al., U.S. Pat. No. 3,542,615; and Harmon, Canadian Patent No. 803,714. Suitable polymers for forming the fibers of the spunbond layer include, but are not limited to, polyolefins, e.g., polyethylene, polypropylene, polybutylene, and the like, and the fibers are advantageously polypropylene.

As used herein, the term “needle punched” generally describes a web of nonwoven fibers that have been converted into a coherent nonwoven fabric on a needle loom or similar device. During needle looming, the fibers of the web are bonded by mechanically orienting fibers through the web with barbed needles that are projected into and withdrawn from the fabric to cause interlocking of the fibers.

As used herein, the term “meltblown layer” refers to a fabric web comprising fibers formed by extruding a molten thermoplastic material through a plurality of fine, usually circular, die capillaries as molten threads or filaments into a high velocity gas (e.g. air) stream which attenuates the filaments of molten thermoplastic material to reduce their diameters, which may be to microfiber diameter. Thereafter, the meltblown fibers are carried by the high-velocity gas stream and are deposited on a collecting surface to form a web of randomly disbursed meltblown fibers. The meltblown process is well-known and is described in various patents and publications, including NRL Report 4364, “Manufacture of Super-Fine Organic Fibers” by V. A. Wendt, E. L. Boone, and C. D. Fluharty; NRL Report 5265, “An Improved Device for the Formation of Super-Fine Thermoplastic Fibers” by K. D. Lawrence, R. T. Lukas, and J. A. Young; and U.S. Pat. No. 3,849,241 issued Nov. 19, 1974 to Buntin et al. Suitable polymers for forming the fibers of the meltblown fabric present invention include, but are not limited to, polyolefins, e.g., polyethylene, polypropylene, polybutylene, and the like. The fibers are advantageously polypropylene.

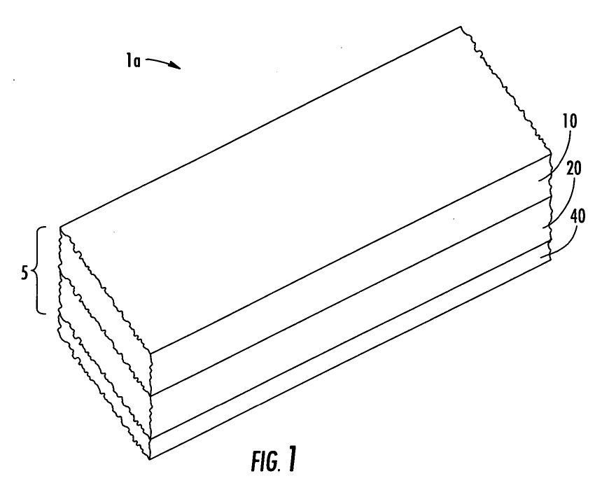

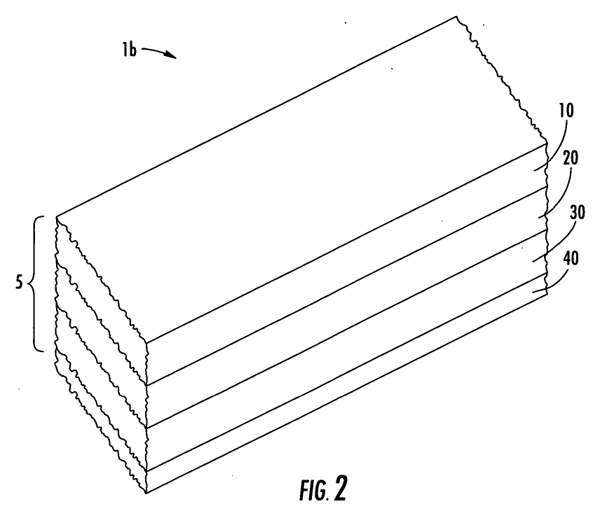

Referring to FIGS. 1 and 2, the invented mat 1a, 1b comprises a nonwoven web laminate 5, having a polymeric film layer 40 adhered to the lower surface of the laminate 5. Referring to FIG. 1, according to one embodiment, the absorbent mat 1a includes a nonwoven laminate 5 and a lower film layer 40, wherein the nonwoven laminate 5 is comprised of an upper spunbond layer 10 and an intermediate meltblown layer 20. The layers are in flush contact with one another in the order presented and each layer is advantageously bonded to its adjacent layers.

Referring to FIG. 2, according to another embodiment, the absorbent mat 1b includes a nonwoven laminate 5 having a polymeric film layer 40 adhered to the lower surface of the laminate 5, wherein the nonwoven laminate 5 is comprised of an upper spunbond layer 10, an intermediate meltblown layer 20, and a lower spunbond layer 30. As with the embodiment of FIG. 1, the layers are in flush contact with one another in the order presented and each layer is advantageously bonded to its adjacent layers.

According to another embodiment, the mat consists essentially of the disclosed layers, i.e. no additional layers that could materially alter the functionality of the mat are interspersed between the described layers of the mat. According to another embodiment, the mat consists of the disclosed layers and no additional layers are interspersed between the described layers.

According to another embodiment, the invented mat may include the layers as described above with reference to FIGS. 1 and 2, but where the upper layer 10 is a needle punched nonwoven layer. According to this embodiment, the needle punched upper layer 10 is generally a needle punched non woven web, which may or may not be a spunbond or meltblown nonwoven.

The upper layer of the laminate may be a spunbond layer, a needle punched layer of any type of nonwoven fibers, or a layer that is both needle punched and spunbond. Further, the layers of the nonwoven laminate may be collectively needle punched to bond the layers of the laminate by mechanical entanglement of the fibers.

The upper layer 10 is comprised of one or more plies of spunbond and/or needle punched material. The upper layer 10 is advantageously from 1 to 5 plies thick, and advantageously has an overall thinner thickness than the underlying meltblown layer 20. The upper layer 10 may be any thickness and density suitable for use in a liquid-absorbent mat, but is advantageously present in an amount of 0.5 to 1.5 oz/yd² (basis weight).

The fibers of the upper layer 10 are advantageously hydrophilic. The fibers can either be naturally hydrophilic or treated to be hydrophilic. According to one embodiment, one or more hydrophilic chemical additives are added to the polymer melt to form hydrophilic fibrous material for hydrophilic spunbond fabrics. Hydrophilic chemical additives include, but are not limited to, one or a combination of additives selected from the following classes of additives: (i) polyoxyalkylene modified fluorinated alkyls, (ii) polyoxyalkylene fatty acid esters, (iii) polyoxyalkylene modified polydimethyl siloxanes and PEG-terephthalate (polyethylene glycol modified terephthalate), and (iv) ethoxylated alkyl phenols. The hydrophilic chemical additives may, alternatively, be added to the fabric following fiber formation or fabric formation. Suitable methods of applying the hydrophilic chemical additives to a nonwoven fabric include, but are not limited to, particle coating, spray coating, or solution coating.

The meltblown layer 20, is comprised of one or more plies of meltblown material, and is also advantageously from 1 to 20 plies thick, preferably from 5 to 10 plies thick. The meltblown layer 20 may be any thickness and density suitable for use in a liquid-absorbent mat, but is advantageously present in an amount of 1 to 40 oz/yd (basis weight), more advantageously from about 5 to about 20 oz/yd², and even more advantageously from about 8 to about 12 oz/yd². The meltblown layer is advantageously hydrophilic as discussed above with regard to the upper spunbond layer 10.

The lower layer 30, if present, is comprised of one or more plies of spunbond material. The lower layer 30 is also advantageously from 1 to 5 plies thick. The lower layer 30 may be any thickness and density suitable for use in a liquid-absorbent mat, but is advantageously present in an amount of 0.5 to 1.5 oz/yd² (basis weight). The fibers of the lower layer 30 are advantageously hydrophobic. The fibers of the layer 30 are further advantageously polyolefin fibers preferably polypropylene fibers, which may be naturally hydrophobic or advantageously treated to make them hydrophobic.

The preferred lower layer 30 provides at least two advantageous functions. One is to provide an extra moisture barrier in case of leaks in the thin film layer 40. By providing a hydrophobic spunbond bottom layer, leaks are avoided. Also, addition of the lower layer 30 tends to improve lamination of the upper spunbond or needle punched and intermediate meltblown layers with the film layer 40, thereby preventing the film layer from tearing in an unpredictable manner.

The nonwoven layers of the laminate 5 are advantageously bonded together with an appropriate bonding method, such as thermal bonding, adhesive bonding, compressive bonding, ultra-sonic bonding, needle punching, or combination thereof. The layers are advantageously spot-bonded, i.e. thermally bonded spots regularly spaced across the plane of the mat.

The film layer 40 is a liquid-impermeable polymeric layer. The film layer is advantageously a polyolefin material and is further advantageously selected from polypropylenes, polyethylenes, copolymers, as well as blends thereof. The thickness of the film layer is advantageously about 0.5 mil to about 2.0 mil and further advantageously about 1.0 mil. The film layer is advantageously made of a non-slip material, i.e. having a high coefficient of friction measured against a hard surface, such as a tile floor. Also, the film layer may be coated with an anti-slip coating material.

The film layer may be adhesively attached to the lower surface of the meltblown layer in the embodiment of the invention having no lower spunbond layer, or may be adhesively attached to the lower surface of the lower spunbond layer where such layer is present. Attachment may be made using any known adhesive that ensures that the layers remain attached during use. Alternatively, when the film and nonwoven fabric contain components that are thermally miscible with or adherent upon thermal activation, the film may be thermally bonded to the nonwoven fabric by heating the film, fabric, or film and fabric to a sufficient temperature and applying sufficient pressure to form unitary, cohesive bonds among the components of the film and lower most nonwoven layer. Moreover, the film may be extrusion coated onto the lowest nonwoven layer.

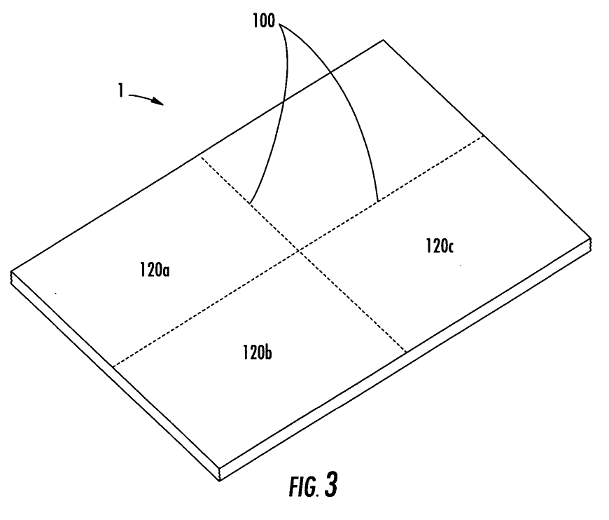

Referring to FIG. 3, the nonwoven web laminate 5 is advantageously divided into at least two separable segments 120a, 120b and 120c by at least one weakening line 100. The “weakening line” is a region of the nonwoven web laminate 5 made less strong so as to permit easy separation along the weakening line either longitudinally or transverse or at an angle to the plane of the mat. Examples of a weakening line are scoring or perforations through at least a partial thickness of the nonwoven web laminate 5. The weakening lines 100 extend through at least a portion of the thickness and preferably fully through the thickness of the laminate layers 10, 20 and 30, but do not extend through the thickness of the film layer 40 so that the film layer 40 is a continuous liquid impermeable layer on the bottom of the mat. “Continuous” as used herein indicates that the polymer film is continuous and impermeable to liquids about the major surface area of the mat and serves as a distinction from any prior art mats that have perforations through both the nonwoven and backing layers thereof.

Using mats of the prior art, it was often difficult to dispose of mats after use because the mats were relatively large and became heavy and unwieldy after they were loaded with liquid. The invented mat may be easily handled after loading by tearing the mat along the weakening lines 100 into individual segments. Upon tearing, the thin film layer 40 is ripped and the nonwoven laminate is easily torn along it scoring or perforation line such that each segment may be easily separated and discarded. The ability to easily separate the mat into segments after loading eliminates the problems associated with unwieldy mats of the prior art.

The nonwoven web laminate 5 of the mat may be scored or perforated by assembling the nonwoven layers and scoring and/or perforating the layers, typically in the cross-direction, machine direction, or both. The film layer is then applied to the pre-scored or pre-perforated layers. The edges of each segment may be sealed, such as by adhesive or thermal bonding through the thickness of the mat 1. The edges may be bonded adjacent to each weakening line 100 in order to minimize the outflow of any loaded liquid upon separation of the segments. Alternatively, the edges of the segments may be left unsealed. Alternatively, the edges of the mat 1 may be sealed, while each segment of the mat is left unsealed along the region adjacent the weakening lines 100 so that fluid may migrate from segment to segment during use.

The web laminate 5 and film layer 40 are sufficiently thin to facilitate tearing of the mat along the weakening lines 100. The overall basis weight of the absorbent materials, i.e. the upper layer 10 and meltblown layer 20, is preferably from about 12 to about 14 oz/yd². The overall basis wait of the lower layer 30, if present, is from about 0.5 to about 1.5 oz/yd². And, the film layer 40 is preferably from about 0.5 mil to about 2.0 mil thick, corresponding to a basis weight of about 3 oz/yd². Overall, the mat is advantageously less than about 25 oz/yd², and more advantageously less than about 20 oz/yd².

The spunbond, needle punched, and/or meltblown fabrics of the mat may be treated with or contain various chemicals in order to impart desirable characteristics. Any such chemical is suitable for the present invention as long as the chemical does not negatively impact desired properties of the mat. Exemplary additives include antistatic agents, fire retardants, antimicrobials, or other desirable chemical finishes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An absorbent mat comprising:
a nonwoven laminate having an upper and a lower surface, said laminate comprising an upper spunbond or needle punched layer and an underlying meltblown layer adjacent to the upper layer; and
a continuous and water-impermeable polymer film layer applied to the lower surface of the nonwoven laminate;
said mat further comprising perforations or scoring extending through at least a portion of the thickness of the nonwoven laminate but not extending through said polymer film layer.

2. The absorbent mat of claim 1, wherein the upper layer is a spunbond layer.

3. The absorbent mat of claim 1, wherein the upper layer is a needle punched layer.

4. The absorbent mat of claim 1, wherein the upper layer is a spunbond and needle punched layer.

5. The absorbent mat of claim 1, wherein the nonwoven laminate comprises
an upper spunbond nonwoven layer; and,
a meltblown nonwoven layer;
wherein the polymer film is applied to the meltblown nonwoven layer.

6. The absorbent mat of claim 5, wherein the upper spunbond layer and intermediate meltblown layer are comprised of hydrophilic fibers.

7. The absorbent mat of claim 1, wherein the laminate is needle punched.

8. The absorbent mat of claim 1, wherein the nonwoven laminate comprises
an upper spunbond nonwoven layer;
an intermediate meltblown nonwoven layer; and,
a lower spunbond nonwoven layer;
wherein the polymer film is applied to the lower spunbond nonwoven layer.

9. The absorbent mat of claim 8, wherein the upper spunbond layer is comprised of hydrophilic fibers and the lower spunbond layer is comprised of hydrophobic fibers.

10. The absorbent mat of claim 1, wherein the polymer film layer is adhesively or thermally bonded to the nonwoven laminate.

11. The absorbent mat of claim 1, wherein the mat is capable of being separated into sections along the perforations or scoring.

12. The absorbent mat of claim 1, wherein the nonwoven laminate comprises
an upper needle punched nonwoven layer; and,
a meltblown nonwoven layer;
wherein the polymer film is applied to the meltblown nonwoven layer.

13. The absorbent mat of claim 12, wherein the upper needle punched layer and intermediate meltblown layer are comprised of hydrophilic fibers.

14. The absorbent mat of claim 12, wherein
the upper needle punched layer is comprised of one or more plies; and,
the intermediate meltblown layer is comprised of one or more plies.

15. The absorbent mat of claim 1, wherein the nonwoven laminate comprises
an upper needle punched nonwoven layer;
an intermediate meltblown nonwoven layer; and,
a lower spunbond nonwoven layer;
wherein the polymer film is applied to the lower spunbond nonwoven layer.

16. The absorbent mat of claim 15, wherein the upper needle punched layer is comprised of hydrophilic fibers and the lower spunbond layer is comprised of hydrophobic fibers.

17. An absorbent mat comprising:
a nonwoven laminate having an upper spunbond or needle punched layer of hydrophilic fibers adjacent to an intermediate meltblown nonwoven layer of hydrophilic fibers adjacent to a lower nonwoven layer of hydrophobic fibers; and,
a continuous and water-impermeable polymer film layer attached to the lower layer.

18. The absorbent mat of claim 17, wherein perforations or scoring extend through at least a portion of the thickness of the nonwoven laminate and the mat comprises at least two segments separable about the perforations or scoring, wherein the polymer film does not substantially prevent the mat from being torn along the perforations or scoring.

19. A method of making an absorbent mat that is easily separated into segments, the method comprising the steps of
forming a nonwoven laminate having an upper and lower surface, said laminate comprising an upper spunbond and/or needle punched layer adjacent to an underlying meltblown layer;
scoring or perforating the nonwoven laminate through at least a partial thickness of the nonwoven laminate, thereby defining segments of the mat divided by at least one weakening line; and
applying a continuous water-impermeable film layer to the lower surface of the scored or perforated laminate.

20. A method of separating a mat loaded with a liquid, the steps comprising
providing the absorbent mat of claim 1;
loading the mat with a liquid; and
separating the loaded mat about the perforations or scoring into at least two segments.
